(19) United States
(12) Patent Application Publication
(10) Pub. No.: US 2024/0133831 A1
(43) Pub. Date: Apr. 25, 2024

(54) SYSTEMS AND METHODS FOR DETERMINING AT LEAST ONE PROPERTY OF FLUID

(71) Applicant: Koch-Glitsch, LP, WICHITA, KS (US)

(72) Inventors: Izak Nieuwoudt, Wichita, KS (US); Anand Vennavelli, Wichita, KS (US)

(21) Appl. No.: 18/278,018

(22) PCT Filed: Mar. 13, 2022
(86) PCT No.: PCT/IB2022/052285

§ 371 Date: Aug. 20, 2023

Related U.S. Application Data
(60) Provisional application No. 63/161,527, filed on Mar. 16, 2021.

(51) Int. Cl. G01N 25/08; G01K 11/32

(52) U.S. Cl. CPC G01N 25/085; G01K 11/32

(57) ABSTRACT

A system for determining a property of a fluid includes a sensing cable including an optical fiber sensor array located within the sensing cable; a heating element aligned with the optical fiber sensor array; and a nucleating surface, surrounding the sensing cable, to induce boiling of the fluid exposed to the nucleating surface when heated by the heating element. A system for determining a property of a fluid includes a sensing cable including an optical fiber sensor array located within the sensing cable; and a heating element, aligned with the optical fiber sensor array, to continuously heat the fluid exposed to the sensing cable. A system for determining a property of a fluid includes a sensing cable including an optical fiber sensor array; and a heating element, aligned with the optical fiber sensor array, to heat the fluid exposed to the sensing cable to induce nucleate boiling of the fluid.

### CROSS-REFERENCE TO RELATED APPLICATION(S)

This application claims priority to U.S. Provisional Application No. 63/161,527, entitled “SYSTEMS AND METHODS FOR DETERMINING AT LEAST ONE PROPERTY OF FLUID”, filed Mar. 16, 2021, the contents of which is hereby incorporated by reference in its entirety.

### BACKGROUND

In a variety of industrial manufacturing environments, it is challenging to make accurate, high-spatial-density measurements of fluid properties. This problem is exacerbated by high temperatures, high pressures, chemically caustic systems, complex mixtures of chemicals, and systems with multiple states of matter present in a volume. Manufacturing systems and processing plants in the petroleum and petrochemical industry frequently exhibit many or all of these challenges, making monitoring physical and fluid properties challenging. However, close monitoring of system parameters (e.g. temperature, pressure, fluid level, and state of matter) can increase the efficiency of industrial processes and can help mitigate emission and production of harmful or environmentally dangerous chemicals. As a result, better monitoring systems are desired that can withstand harsh environments while providing valuable measurements of systems that are otherwise challenging to monitor.

### SUMMARY OF THE INVENTION

In an embodiment, a method for determining at least one property of a fluid includes: heating the fluid exposed to a sensing cable to induce nucleate boiling of the fluid at a nucleating surface at least partly surrounding the sensing cable; and determining the at least one property of the fluid based at least in part on output of the sensing cable.

In an embodiment, a system for determining at least one property of a fluid includes: a sensing cable with an optical fiber sensor array located within the sensing cable; a heating element aligned with the optical fiber sensor array; and a nucleating surface, at least partly surrounding the sensing cable, to induce boiling of the fluid exposed to the nucleating surface when heated by the heating element.

In an embodiment, a method for determining one or more properties of a fluid includes: continuously heating the fluid exposed to a sensing cable; determining the at least one property of the fluid based at least in part on output of the sensing cable.

In an embodiment, a system for determining at least one property of a fluid includes: a sensing cable with an optical fiber sensor array located within the sensing cable; and a heating element, aligned with the optical fiber sensor array, to continuously heat the fluid exposed to the sensing cable.

In an embodiment, a method for determining at least one property of a fluid includes: inducing, with a heating element, nucleate boiling of the fluid exposed to a sensing cable containing the heating element; monitoring, with an optical signal interrogator, output of the sensing cable; and determining the at least one property of the fluid based at least in part on output of the sensing cable.

In an embodiment, a system for determining at least one property of a fluid includes: a sensing cable including an optical fiber sensor array located within the sensing cable; and a heating element, aligned with the optical fiber sensor array, to heat the fluid exposed to the sensing cable to induce nucleate boiling of the fluid.

### BRIEF DESCRIPTION OF THE FIGURES

FIG. 1A shows one system for determining at least one property of fluid, according to embodiments.

FIGS. 1B, 1C and 1D show cross-sectional views of a sensing cable of the system shown in FIG. 1A, according to embodiments.

FIG. 2 is a flowchart illustrating a method for determining at least one property of fluid, according to an embodiment.

FIG. 3 is a flowchart illustrating a method using continuous heating for determining at least one property of fluid, according to an embodiment.

FIG. 4 is a flowchart illustrating a method for determining at least one property of fluid by inducing nucleate boiling of the fluid, according to an embodiment.

FIG. 5 illustrates a graph depicting the relationship of heat flow into a fluid from a heating element as a function of the temperature of the heating element.

### DETAILED DESCRIPTION OF THE EMBODIMENTS

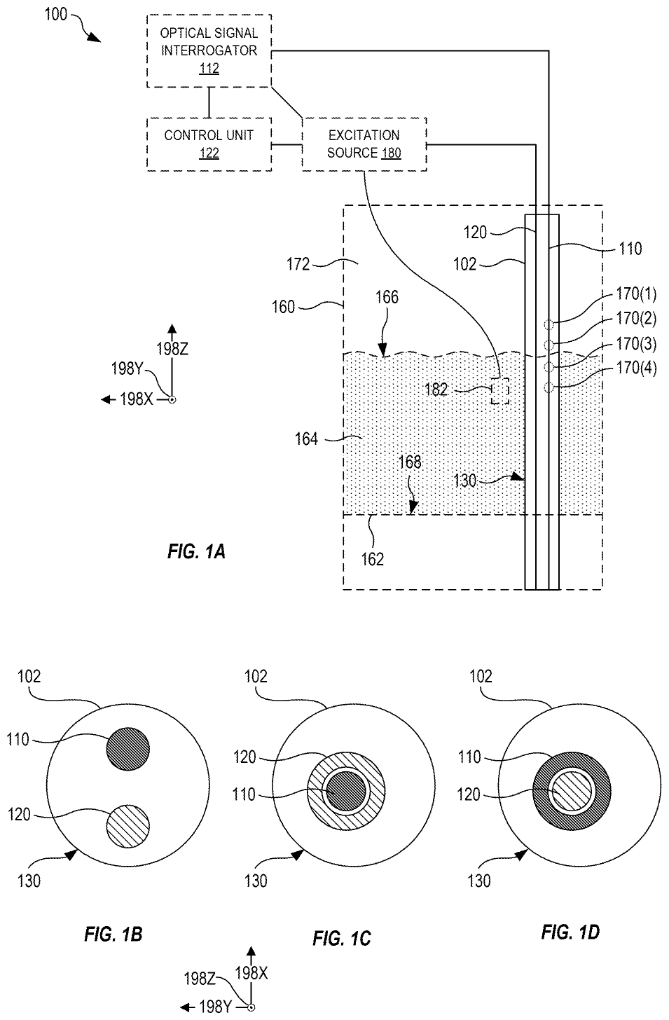

FIG. 1A illustrates a cross-sectional side view of a system 100 for determining at least one property of a fluid 164 using a sensing cable 102 that includes an optical fiber sensor array 110 and a heating element 120. FIGS. 1B, 1C, and 1D illustrate three separate cross-sectional top views of the sensing cable, each showing a configuration of the optical fiber sensor array 110 and heating element 120 within the sensing cable 102. FIGS. 1A, 1B, 1C, and 1D are best viewed together with the following description.

The cross-sectional side view illustrated in FIG. 1A is parallel to a plane, hereinafter the x-z plane, formed by orthogonal axes 198X and 198Z, which are each orthogonal to an axis 198Y. A plane, hereinafter the x-y plane, formed by orthogonal axes 198X and 198Y, and planes parallel to the x-y plane are referred to as horizontal planes. Unless otherwise specified, heights of objects herein refer to the object's extent along axis 198Z. Herein, a reference to an axis x, y, or z refers to axes 198X, 198Y, and 198Z respectively. Also, herein, vertical refers to a direction along the z axis. Also, herein, above refers to a relative position a distance away along the axis 198Z in the positive direction and below refers to a relative position a distance away along the axis 198Z in the negative direction. FIGS. 1B, 1C, and 1D include axes indicators for 198X, 198Y, and 198Z, as shown.

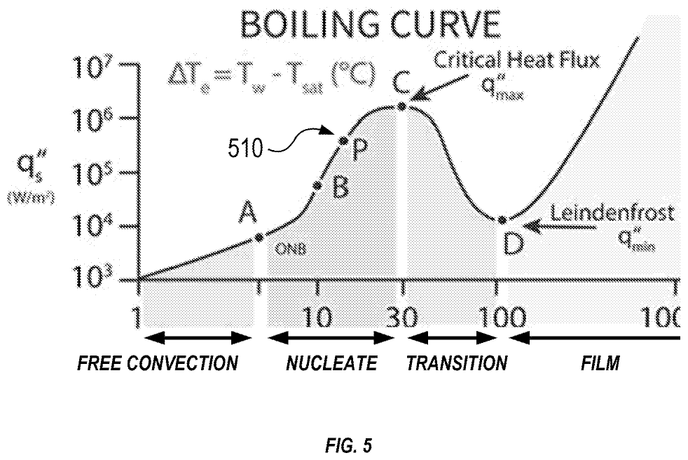

In an embodiment, the sensing cable 102 includes a nucleating surface 130 that at least partially surrounds the sensing cable 102 such that it is exposed to the fluid 164. The nucleating surface 130 may be formed by modifying a nascent surface of the sensing cable 102 by one or more of chemical etching, abrading, scoring, grinding, and laser ablation. In one embodiment, the nucleating surface 130 is formed by atomic layer or chemical vapor deposition onto the nascent surface of the sensing cable 102. Other methods may be used to deposit the nucleating surface 130 without departing from the scope hereof. The nucleating surface 130 aids in inducing boiling of the fluid 164, which is advantageous because boiling increases the rate of heat flow from the heating element 120 into the fluid 164. Greater heat flow allows more sensitive measurements to be made by the sensing cable 102, as will be discussed below in association with FIG. 5.

In the embodiment shown in FIG. 1A, the system 100 includes an optical signal interrogator 112 communicatively coupled with the optical fiber sensor array 110. The optical signal interrogator 112 monitors the output of the sensing cable 102 to determine at least one property of the fluid 164 based at least in part on the output of the sensing cable 102. In an embodiment, the optical signal interrogator 112 is adapted to measure temperature and the output of the sensing cable corresponds to a temperatures measurement.

In the embodiment shown in FIG. 1A, the system 100 includes a control unit 122 coupled to the optical signal interrogator 112 that classifies the output of the sensing cable 102 as one of a predetermined set of classifications including at least a stable condition classification and an unstable condition classification. Use of these classifications are described in more detail below.

In an embodiment, the fluid 164 is located in a tray 162 of a distillation column 160. The tray has a bottom surface 168 and the fluid 164 has an interface 166 that separates the fluid 164 from a surrounding atmosphere 172. As shown in FIG. 1A, the optical fiber sensor array 110 includes a plurality of sensor locations 170 that align orthogonally to the bottom surface 168. Although one distillate tray is shown in FIG. 1A, the optical fiber sensor array 110 may traverse through one or more of the distillate trays within the distillation column 160 to provide sensed data at a variety of locations throughout the distillate column 160. As such, the systems and methods discussed herein may be used in conjunction with the systems and methods discussed in U.S. Patent Application Ser. No. 63/053,132, filed Jul. 17, 2020, which is included herein as Appendix A.

The control unit 122 is further configured to determine the at least one property of the fluid 164 exposed to the sensing cable 102 by identifying at least one interface (e.g. interface 166) between one of more of (a) two phases of matter present within the fluid (b) two species present within the fluid, and (c) the fluid and the surrounding atmosphere. The plurality of sensor locations 170 implies a sensor, from the fiber sensor array 110, at each of the four sensor locations (170(1), 170(2), 170(3), and 170(4)) that are equally spaced along the optical fiber sensor array 110, though more or fewer sensor locations may be used with different physical alignment without departing from the scope hereof. In embodiments herein, the sensing cable 102 may be located in a variety of locations, such as the tray itself, the downcomer of the tray, or other auxiliary tower internals such as distributors. The sensor locations may be equally or unequally spaced without departing from the scope hereof.

The control unit 122 may be configured to identify the interface 166 (or another interface such as between different phases of matter within fluid 164) by determining a difference in the output of the sensing cable 102 corresponding to adjacent sensor locations of the plurality of sensor locations 170. For example, the level of the interface 166 falls between sensor location 170(2) and sensor locations 170(3) and the difference in the output of the sensing cable 102 corresponding to sensors locations 170(2) and 170(3) is used to identify the interface 166 between the fluid 164 and the surrounding atmosphere 172 above the fluid 164. The shape and relative dimensions of the tray 162 and distillation column 160 are for illustrative purposes only and are not meant to limit the embodiment illustrated in FIG. 1A.

As noted above, FIGS. 1B, 1C, and 1D show cross-sectional side views of a sensing cable 102 of the system 100 shown in FIG. 1A. FIG. 1B illustrates one embodiment where the optical fiber sensor array 110 and heating element 120 are spaced apart and are not overlapped. FIG. 1C illustrates an embodiment where the optical fiber sensor array 110 is enclosed by the heating element 120. FIG. 1D illustrates an embodiment where the heating element 120 is enclosed by the optical fiber sensor array 110. In any of the embodiments illustrated in FIGS. 1B-1D, the sensing cable 102 may include a nucleating surface 130 that at least partially surrounds the sensing cable 102.

The embodiments of FIGS. 1B, 1C, and 1D thus illustrate various topologies of the sensing cable 102, optical fiber sensor array 110, and heating element 120 with respect to each other when viewed in cross section. The shapes, relative sizes, and relative positions of the cross sections of the sensing cable 102, the optical fiber sensor array 110, and the heating element 120 may vary without departing from the scope hereof.

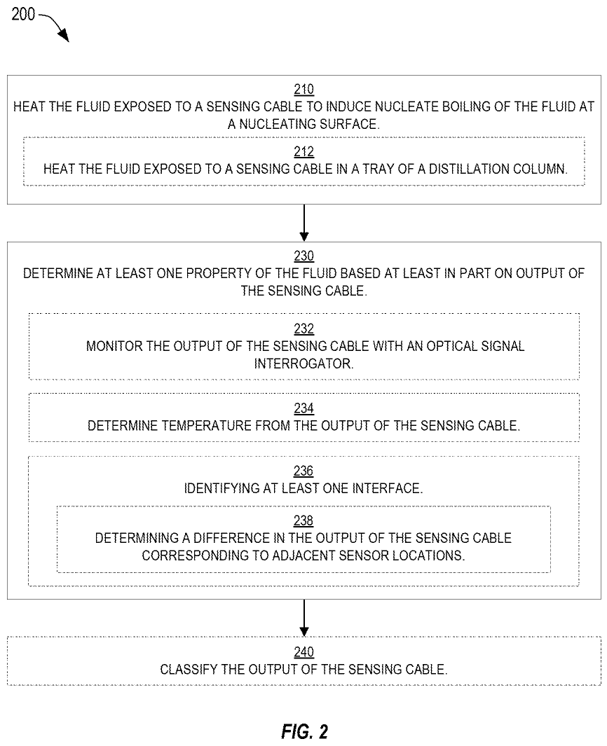

FIG. 2 is a flowchart illustrating a method 200 for determining at least one property of fluid. The method 200 may be used in conjunction with the system 100 of FIGS. 1A-1D, including the nucleating surface 130, according to an embodiment. Method 200 includes blocks 210 and block 230. Method 200 may also include at least one of blocks 212, 232, 234, 236, 238, and 240 as shown.

In block 210 of method 200, fluid exposed to a sensing cable is heated to induce nucleate boiling of the fluid at a nucleating surface at least partly surrounding the sensing cable. In one example of block 210, the fluid 164 exposed to the sensing cable 102 is heated to induce nucleate boiling of the fluid 164 at the nucleating surface 130.

In block 230 of the method 200, at least one property of the fluid is determined based at least in part on the output of the sensing cable. In one example of block 230, at least one property of the fluid 164 is determined based at least in part on the output of the sensing cable 102.

Specifically, as part of block 230, block 232 may monitor the output of the sensing cable by an optical signal interrogator. In one example of block 232, output of the sensing cable 102 is monitored by an optical signal interrogator 112.

In block 234, a temperature is determined from the output of the signal cable. In one example of block 234, a temperature is determined from the output of the sensing cable 102 by monitoring the signal output from the sensor and correlating the output signal to a known temperature profile.

In block 240, the output of the sensing cable is classified as one classification in a set of classifications including at least a stable condition classification and an unstable condition classification, determined at least in part from the output of the sensing cable, e.g. sensing cable 102. When the output of the sensing cable is classified as the unstable condition, an error message may be transmitted to indicate that one or more physical properties of the fluid 164 are not within the limits of a desired condition, e.g., the temperature exceeds a safe operating temperature. When the output of the sensing cable is classified as the stable condition, the system 100 may store the classification and time stamp to monitor efficiency over time of the system with respect to one or more physical properties of the fluid 164.

The outputs of blocks 230 and 240 may be used by a process controller, such as that disclosed in U.S. Patent Application Ser. No. 63/053,132, filed Jul. 17, 2020, which is included herein as Appendix A.

In block 212, the fluid exposed to a sensing cable in a tray of a distillation column is heated. In one example of block 212, the fluid 164 exposed to the sensing cable 102 located in a tray 162 of a distillation column 160 is heated by heating element 120. In embodiments herein, the sensing cable 102 may be located in additional or alternative locations, such as the tray itself, the down corner of the tray, or other auxiliary tower internals such as distributors.

In block 236 at least one interface is identified between one or more of (a) two phases of matter present within the fluid (b) two species present within the fluid, and (c) the fluid and the surrounding atmosphere. In one example of block 236, the interface 166 is identified between the fluid 164 and the surrounding atmosphere 172.

In block 238, a sub-block of block 236, at least one interface is identified by determining a difference in the output of the sensing cable corresponding to adjacent sensor locations of a plurality of sensor locations, the plurality of sensors locations aligned orthogonally to the bottom surface of the tray. In one example of block 238, the interface 166 is identified by determining a difference in the output of the sensing cable 102 corresponding to sensor location 170(2) and sensor location 170(3), as shown in the example of FIG. 1.

In an embodiment of the system 100 of FIGS. 1A-1D, the heating element 120 continuously heats the fluid 164 in contact with the sensing cable 102. In this embodiment, the fluid 164 exposed to the sensing cable 102 may reach a steady-state temperature based at least upon physical and chemical properties of the fluid 164. The output of the sensing cable 102 corresponds to a temperature measurement, which is used to determine the at least one property of the fluid 164. With continuous heat input from the heating element 120, the rate of heat dissipation into the fluid 164 is a function of the heat transfer coefficient into the fluid 164 and the particular phase or phases of matter present within the fluid, e.g. liquid, vapor, froth, etc. This rate of heat dissipation thus determines the steady-state temperature of the fluid 164 exposed to the sensing cable 102 and therefore determines the output of the sensing cable 102. The differences in steady-state temperature exhibited by different phases of matter are useful in determining (a) the phase(s) of the fluid 164 in contact with the sensing cable 102 at a given location (e.g. sensor location 170(1) and (b) determining the position of an interface (e.g. the interface 166 between the fluid 164 and the surrounding atmosphere 172). Operating the heating element 120 with continuous heating therefore aids in the detection of phase information, such as detection of phases of matter and/or an interface. But heating by the heating element 120 may alternatively be applied in a step mode, e.g., heating for 30 seconds and then not heating for 30 seconds, or heating for 30 seconds at one heating rate and then heating for 30 second at a different heating rate. The duration and pattern of the step mode may vary without departing from the scope hereof.

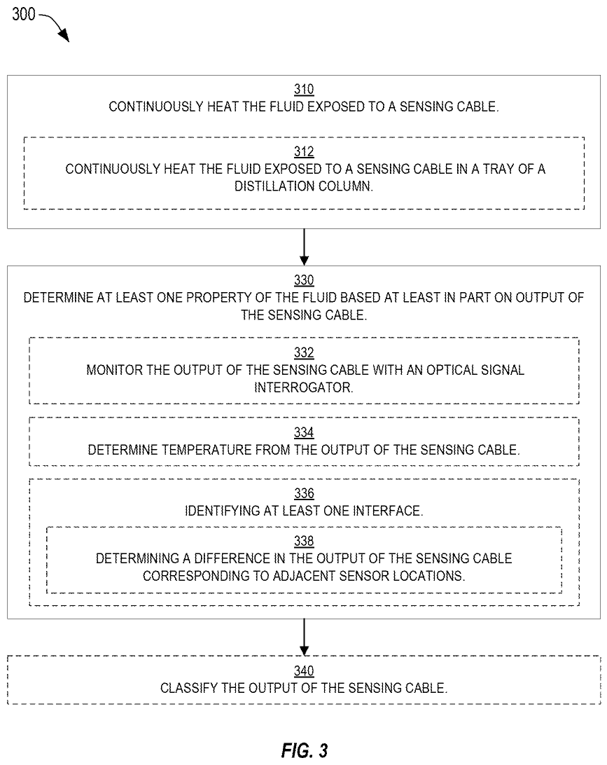

FIG. 3 is a flowchart illustrating a method 300 using continuous heating for determining at least one property of a fluid. The method 300 is for example used with the system 100 of FIGS. 1A-1D, according to an embodiment. Method 300 includes blocks 310 and block 330. In embodiments, method 300 also includes at least one of blocks 312, 332, 334, 336, 338, and 340.

In block 310 of method 300, fluid exposed to a sensing cable is continuously heated. In one example of block 310, the fluid 164 exposed to the sensing cable 102 is continuously heated by heating element 120.

In block 330 of the method 300, at least one property of the fluid is determined based at least in part on the output of the sensing cable. In one example of block 330, at least one property of the fluid 164 is determined based at least in part on the output of the sensing cable 102.

In block 332, the output of the sensing cable is monitored by an optical signal interrogator. In one example of block 332, output of the sensing cable 102 is monitored by the optical signal interrogator 112.

In block 334, a temperature is determined from the output of the signal cable. In one example of block 334, a temperature is determined from the output of the sensing cable 102.

In block 340, the output of the sensing cable is classified as one classification in a set of classifications including at least a stable condition classification and an unstable condition classification, determined based at least in part upon the output of the sensing cable, e.g. sensing cable 102.

In block 312, the fluid exposed to a sensing cable in a tray of a distillation column is continuously-heated. In one example of block 312, the fluid 164 exposed to the sensing cable 102 located in a tray 162 of a distillation column 160 is continuously heated by the heating element 120.

In block 336 at least one interface is identified between one or more of (a) two phases of matter present within the fluid (b) two species present within the fluid, and (c) the fluid and a surrounding. In one example of block 336, the interface 166 is identified between the fluid 164 and the surrounding atmosphere 172.

In block 338, least one interface is identified by determining a difference in the output of the sensing cable corresponding to adjacent sensor locations of a plurality of sensor locations. In one example of block 338, the interface 166 is identified by determining a difference in the output from a plurality of sensors locations aligned orthogonally to the bottom surface of the tray 162 for the sensing cable 102, for example corresponding to sensor location 170(2) and sensor location 170(3) in the example of FIG. 1A.

In an embodiment, the system 100 of FIGS. 1A-1D includes an excitation source 180 communicatively coupled to the optical signal interrogator 112. The excitation source 180 controls the heating element 120 with a heat signal and the heating element 120 heats the fluid 164 exposed to the sensing cable 102 to induce nucleate boiling of the fluid 164. The conditions of nucleate boiling are illustrated graphically in FIG. 5, which will be discussed in more detail below. Inducing nucleate boiling of the fluid 164 increases the sensitivity of the sensing cable 102 by exploiting the differences in heat transfer rates between difference phases of matter for a given fluid. In an embodiment, the heat signal is chosen based at least in part on a set point temperature. The set point temperature may be determined so that the heating element 120 heats the fluid 164 to a temperature that allows higher sensitivity or enhanced ability to detect phase of fluid or an interface, for example. For a given fluid, the set point may be determined to maximize heat flow into the fluid 164 based upon known thermodynamic properties and of the fluid, for example as illustrated in FIG. 5 and described below. In an embodiment, the heat signal is chosen based at least in part on the output of the sensing cable 102. In an embodiment, the heat signal is chosen based at least in part on a measurement made by a secondary sensor 182 communicatively coupled to the excitation source 180. The secondary sensor 182 may for example be located in the distillation column 160 proximal to the tray 162. The secondary sensor 182 may be located further or closer to the tray 162 and further, or closer, to the sensing cable 102 without departing from the scope hereof. The location of the secondary sensor 182 need not be located within the distillation column 160, for example it may be located near an output or input of the distillation column, not shown in FIG. 1A.

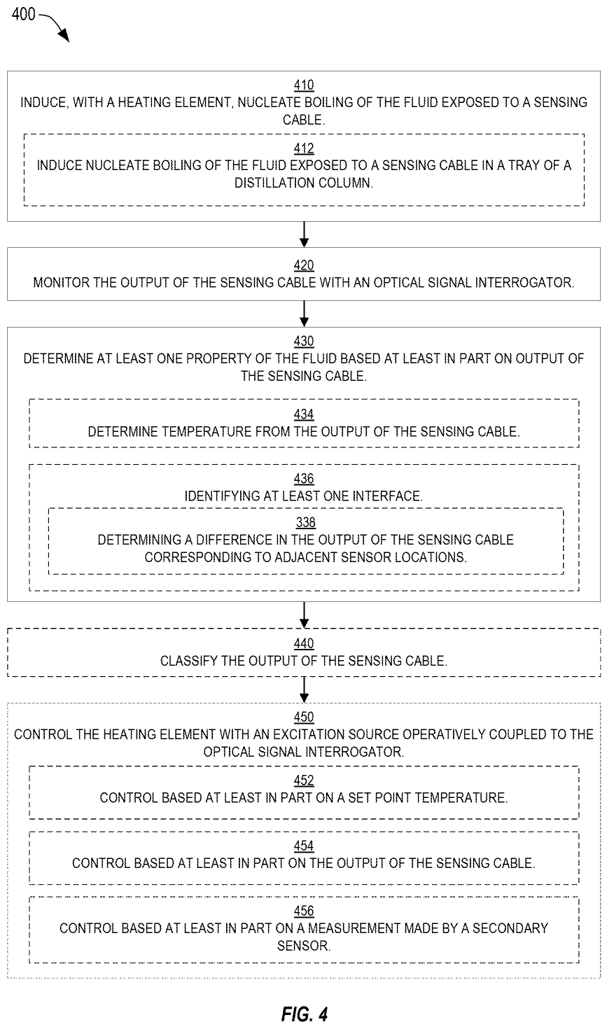

FIG. 4 is a flowchart illustrating a method 400 for determining at least one property of a fluid by inducing nucleate boiling of the fluid. The method 400 is for example used with the system 100 of FIGS. 1A-1D, according to an embodiment. Method 400 includes blocks 410, 420, and 430. In embodiments, method 400 also includes at least one of blocks 412, 434, 436, 438, 440, 450, 452, 454, and 456.

In block 410 of method 400, fluid exposed to a sensing cable is heated with a heating element contained in the sensing cable to induce nucleate boiling of the fluid. In one example of block 410, the fluid 164 exposed to the sensing cable 102 is continuously heated with the heating element 120 to induce nucleate boiling of the fluid 164.

In block 420, the output of the sensing cable is monitored with an optical signal interrogator. In one example of block 420, the output of the sensing cable 102 is monitored with the optical signal interrogator 112.

In block 430 of the method 400, at least one property of the fluid is determined based at least in part on the output of the sensing cable. In one example of block 430, at least one property of the fluid 164 is determined based at least in part on the output of the sensing cable 102.

In certain embodiment, the method 400 includes one or more additional blocks of the flowchart in FIG. 4. In block 434, a temperature is determined from the output of the signal cable. In one example of block 434, a temperature is determined from the output of the sensing cable 102.

In block 440, the output of the sensing cable is classified as one classification in a set of classifications including at least a stable condition classification and an unstable condition classification, determined based at least in part upon the output of the sensing cable, e.g., sensing cable 102.

In block 450, the heating element is controlled with an excitation source communicatively coupled with the optical signal interrogator. In one example of block 450, the heating element 120 is controlled with the excitation source 180 communicatively coupled with the optical signal interrogator 112.

In block 452, the heating element is controlled with the excitation source based at least in part on a set point temperature. In one example of block 452, the heating element 120 is controlled with the excitation source 180 based at least in part on a set point temperature.

In block 454, the heating element is controlled with the excitation source based at least in part on the output of the sensing cable. In one example of block 454, the heating element 120 is controlled with the excitation source 180 based at least in part on the output of the sensing cable 102.

In block 456, the heating element is controlled with the excitation source based at least in part on a measurement made by a secondary sensor communicatively coupled with the excitation source. In one example of block 456, the heating element 120 is controlled with the excitation source 180 based at least in part on a measurement made by a secondary sensor 182 communicatively coupled with the excitation source 180.

In block 412, the fluid exposed to a sensing cable in a tray of a distillation column is heated to induce nucleate boiling. In one example of block 412, the fluid 164 exposed to the sensing cable 102 located in a tray 162 of a distillation column 160 is heated to induce nucleate boiling.

In block 436 at least one interface is identified between one or more of (a) two phases of matter present within the fluid (b) two species present within the fluid, and (c) the fluid and a surrounding. In one example of block 436, the interface 166 is identified between the fluid 164 and the surrounding atmosphere 172.

In block 438, least one interface is identified by determining a difference in the output of the sensing cable corresponding to adjacent sensor locations of a plurality of sensor locations, the plurality of sensors locations aligned orthogonally to the bottom surface of the tray. In one example of block 438, the interface 166 is identified by determining a difference in the output of the sensing cable 102 corresponding to the plurality of sensor locations 170, such as between sensor location 170(2) and sensor location 170(3) illustratively shown in FIG. 1A.

FIG. 5 illustrates a graph depicting the relationship of heat flow into a fluid from a heating element (e.g. heat flow into fluid 164 from heating element 120) as a function of the temperature of the heating element. In the embodiments described herein, nucleate boiling is illustrated as the second-from-the-left region labeled with the word “Nucleate”. This temperature range for a given fluid corresponds to efficient transfer of energy into the fluid. Heating a fluid with a heating element within the nucleate boiling regime causes more efficient and more stable heat flux into the fluid than the adjacent heating regimes illustrated in FIG. 5: “Free-Convection”, the left-most region, and “Transition”, the second-from-right region. Heating a fluid to induce nucleate boiling, which is to say heating to the temperature range consistent with the region indicated as “Nucleate” leads to higher-sensitivity measurements of the steady-state temperature e.g. measurements as described above. Thermodynamic information like that conveyed in FIG. 5 is used to determine a set point temperature to increase the sensitivity of system 100 and may be used in the method 400 above. For example, the set point for the system 100 may use a set point temperature for the heating element 120 that corresponds to a bubble point 510 on the graph shown in FIG. 5.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combination of Features

(A1) In a first aspect, a method for determining at least one property of a fluid includes heating the fluid exposed to a sensing cable to induce nucleate boiling of the fluid at a nucleating surface at least partly surrounding the sensing cable; and determining the at least one property of the fluid based at least in part on output of the sensing cable

(A2) In an embodiment of A1, the step of determining further includes monitoring the output of the sensing cable with an optical signal interrogator.

(A3) In an embodiment of either A1 or A2, determining further includes determining temperature from the output of the sensing cable

(A4) In an embodiment of any of A1 through A3, the method further includes classifying the output of the sensing cable as one classification in a set of classifications including at least a stable condition classification and an unstable condition classification, determined based at least in part upon the output of the sensing cable.

(A5) In an embodiment of any of A1 through A4, wherein heating the fluid exposed to a sensing cable further includes heating the fluid exposed to a sensing cable in a tray of a distillation column.

(A6) In an embodiment of any of A1 through A5, determining further includes identifying at least one interface between one or more of (a) two phases of matter present within the fluid (b) two species present within the fluid, and (c) the fluid and a surrounding atmosphere.

(A7) In an embodiment of any of A1 through A6, wherein identifying at least one interface includes determining a difference in the output of the sensing cable corresponding to adjacent sensor locations of a plurality of sensor locations, the plurality of sensors locations aligned orthogonally to the bottom surface of the tray.

(B1) In a second aspect, a system for determining at least one property of a fluid includes a sensing cable including an optical fiber sensor array located within the sensing cable; a heating element aligned with the optical fiber sensor array; and a nucleating surface, at least partly surrounding the sensing cable, to induce boiling of the fluid exposed to the nucleating surface when heated by the heating element.

(B2) In an embodiment of B1, the system further including an optical signal interrogator, communicatively coupled with the optical fiber sensor array, to monitor output of the sensing cable and determine the at least one property based at least in part on the output of the sensing cable.

(B3) In an embodiment of either B1 or B2, wherein the optical signal interrogator is adapted to measure temperature and wherein the output of the sensing cable corresponds to a temperature measurement.

(B4) In an embodiment of any of B1 through B3, the system further including a control unit, coupled to the optical signal interrogator, to classify the output of the sensing cable as one of a predetermined set of classifications including at least a stable condition classification and an unstable condition classification, determined based at least in part upon the output of the sensing cable.

(B5) In an embodiment of any of B1 through B4, the fluid located in a tray of a distillation column.

(B6) In an embodiment of any of B1 through B5, wherein the optical fiber sensor array further includes a plurality of sensor locations aligned orthogonally to a bottom surface of the tray, and wherein the control unit is further configured to determine the at least one property of the fluid exposed to the sensing cable by identifying at least one interface between one or more of (a) two phases of matter present within the fluid (b) two species present within the fluid, and (c) the fluid and a surrounding atmosphere.

(B7) In an embodiment of any of B1 through B6, the control unit is further configured to identify the at least one interface by determining a difference in the output of the sensing cable corresponding to adjacent sensor locations of a plurality of sensor locations.

(C1) In a third aspect, a method for determining one or more properties of a fluid includes continuously heating the fluid exposed to a sensing cable; determining the at least one property of the fluid based at least in part on output of the sensing cable.

(C2) In an embodiment of C1, the step of determining further includes monitoring the output of the sensing cable with an optical signal interrogator.

(C3) In an embodiment of either C1 or C2, wherein determining further includes determining temperature from the output of the sensing cable.

(C4) In an embodiment of any of C1 through C3, the method further includes classifying the output of the sensing cable as one classification in a set of classifications including at least a stable condition classification and an unstable condition classification, determined based at least in part upon the output of the sensing cable.

(C5) In an embodiment of any of C1 through C4, wherein continuously heating the fluid exposed to a sensing cable further includes continuously heating the fluid exposed to a sensing cable in a tray of a distillation column.

(C6) In an embodiment of any of C1 through C5, wherein determining includes identifying at least one interface between one or more of (a) two phases of matter present within the fluid (b) two species present within the fluid, and (c) the fluid and a surrounding atmosphere.

(C7) In an embodiment of any of C1 through C6, where identifying at least one interface includes determining a difference in the output of the sensing cable corresponding to adjacent sensor locations of a plurality of sensor locations, the plurality of sensors locations aligned orthogonally to the bottom surface of the tray.

(D1) In a fourth aspect, a system for determining at least one property of a fluid includes a sensing cable including an optical fiber sensor array located within the sensing cable; and a heating element, aligned with the optical fiber sensor array, to continuously heat the fluid exposed to the sensing cable.

(D2) In an embodiment of D1, the system further includes an optical signal interrogator, communicatively coupled with the optical fiber sensor array, to monitor output of the sensing cable and determining the at least one property based at least in part on the output of the sensing cable.

(D3) In an embodiment of either D1 or D2, wherein the optical signal interrogator is adapted to measure temperature and wherein the output of the sensing cable corresponds to a temperature measurement.

(D4) In an embodiment of any of D1 through D3, the system further includes a control unit, coupled to the optical signal interrogator, to classify the output of the sensing cable as one of a predetermined set of classifications including at least a stable condition classification and an unstable condition classification, determined based at least in part upon the output of the sensing cable.

(D5) In an embodiment of any of D1 through D4, the fluid located in a tray of a distillation column.

(D6) In an embodiment of any of D1 through D5, wherein the optical fiber sensor array further includes a plurality of sensor locations aligned orthogonally to a bottom surface of the tray, and wherein the control unit is further configured to determine the at least one property of the fluid exposed to the sensing cable by identifying at least one interface between one or more of (a) two phases of matter present within the fluid (b) two species present within the fluid, and (c) the fluid and a surrounding atmosphere.

(D7) In an embodiment of any of D1 through D6, the control unit is further configured to identify the at least one interface by determining a difference in the output of the sensing cable corresponding to adjacent sensor locations of a plurality of sensor locations.

(E1) In a fifth aspect, a method for determining at least one property of a fluid includes inducing, with a heating element, nucleate boiling of the fluid exposed to a sensing cable containing the heating element; monitoring, with an optical signal interrogator, output of the sensing cable; and determining the at least one property of the fluid based at least in part on output of the sensing cable.

(E2) In an embodiment of E1, wherein determining further includes determining temperature from the output of the sensing cable.

(E3) In an embodiment of either E1 or E2, the method further includes classifying the output of the sensing cable as one classification in a set of classifications including at least a stable condition classification and an unstable condition classification, determined based at least in part upon the output of the sensing cable.

(E4) In an embodiment of any of E1 through E3, the method further including controlling the heating element with an excitation source communicatively coupled with the optical signal interrogator.

(E5) In an embodiment of any of E1 through E4, said controlling based at least in part on a set point temperature.

(E6) In an embodiment of any of E1 through E5, said controlling based at least in part on the output of the sensing cable.

(E7) In an embodiment of any of E1 through E6, said controlling based at least in part on a measurement made by a secondary sensor communicatively coupled with the excitation source.

(E8) In an embodiment of any of E1 through E7, inducing further includes inducing, with a heating element, nucleate boiling of the fluid exposed to a sensing cable in a tray of a distillation column.

(E9) In an embodiment of any of E1 through E8, wherein determining includes identifying at least one interface between one or more of (a) two phases of matter present within the fluid (b) two species present within the fluid, and (c) the fluid and a surrounding atmosphere.

(E10) In an embodiment of any of E1 through E9, where identifying at least one interface includes determining a difference in the output of the sensing cable corresponding to adjacent sensor locations of a plurality of sensor locations, the plurality of sensors locations aligned orthogonally to the bottom surface of the tray.

(F1) In a sixth aspect, a system for determining at least one property of a fluid includes a sensing cable including an optical fiber sensor array located within the sensing cable; and a heating element, aligned with the optical fiber sensor array, to heat the fluid exposed to the sensing cable to induce nucleate boiling of the fluid.

(F2) In an embodiment of F1, the system further includes an optical signal interrogator, communicatively coupled with the optical fiber sensor array, to monitor output of the sensing cable and determine the at least one property based at least in part on the output of the sensing cable.

(F3) In an embodiment of either F1 or F2, wherein the optical signal interrogator is adapted to measure temperature and wherein the output of the sensing cable corresponds to a temperature measurement.

(F4) In an embodiment of any of F1 through F3, the system further includes a control unit, coupled to the optical signal interrogator, to classify the output of the sensing cable as one of a predetermined set of classifications including at least a stable condition classification and an unstable condition classification, determined based at least in part upon the output of the sensing cable.

(F5) In an embodiment of any of F1 through F4, the fluid being located in a tray of a distillation column.

(F6) In an embodiment of any of F1 through F5, wherein the optical fiber sensor array further includes a plurality of sensor locations aligned orthogonally to a bottom surface of the tray, and wherein the control unit is further configured to determine the at least one property of the fluid exposed to the sensing cable by identifying at least one interface between one or more of (a) two phases of matter present within the fluid (b) two species present within the fluid, and (c) the fluid and a surrounding atmosphere.

(F7) In an embodiment of any of F1 through F6, the control unit is further configured to identify the at least one interface by determining a difference in the output of the sensing cable corresponding to adjacent sensor locations of a plurality of sensor locations.

(F8) In an embodiment of any of F1 through F7, the system further includes an excitation source, communicatively coupled with the optical signal interrogator, to control the heating element with a heat signal.

(F9) In an embodiment of any of F1 through F8, the heat signal chosen based at least in part on a set point temperature.

(F10) In an embodiment of any of F1 through F9, the heat signal chosen based at least in part on the output of the sensing cable.

(F11) In an embodiment of any of F1 through F10, the heat signal chosen based at least in part on a measurement made by a secondary sensor communicatively coupled with the excitation source.

(F12) In an embodiment of any of F1 through F11, the secondary sensor located in the distillation column proximal to the tray.

1. A method for determining at least one property of a fluid, comprising:
heating the fluid exposed to a sensing cable to induce nucleate boiling of the fluid at a nucleating surface at least partly surrounding the sensing cable; and
determining the at least one property of the fluid based at least in part on output of the sensing cable.

2. The method of claim 1, the step of determining the at least one property of the fluid further comprising monitoring the output of the sensing cable with an optical signal interrogator.

3. The method of claim 1, wherein determining the at least one property of the fluid further comprises determining temperature from the output of the sensing cable

4. The method of claim 1, further comprising:
classifying the output of the sensing cable as one classification in a set of classifications including at least a stable condition classification and an unstable condition classification, determined based at least in part upon the output of the sensing cable.

5. The method of claim 1, wherein the heating the fluid exposed to a sensing cable further comprising heating the fluid exposed to the sensing cable in a tray of a distillation column.

6. The method of claim 5, wherein the determining the at least one property of the fluid further comprises identifying at least one interface between one or more of (a) two phases of matter present within the fluid, (b) two species present within the fluid, and (c) the fluid and a surrounding atmosphere.

7. The method of claim 6, wherein the identifying at least one interface further comprises determining a difference in the output of the sensing cable corresponding to adjacent sensor locations of a plurality of sensor locations, the plurality of sensors locations aligned orthogonally to a bottom surface of the tray.

8. The method of claim 1, wherein the heating the fluid exposed to a sensing cable further comprises continuously heating the fluid exposed to the sensing cable.

9. The method of claim 2, further comprising controlling the heating element with an excitation source communicatively coupled with the optical signal interrogator.

10. The method of claim 9, wherein the controlling the heating element is based at least in part on a measurement made by a secondary sensor communicatively coupled with the excitation source.

11. A system for determining at least one property of a fluid, comprising:
a sensing cable including an optical fiber sensor array located within the sensing cable;
a heating element aligned with the optical fiber sensor array; and
a nucleating surface, at least partly surrounding the sensing cable, to induce boiling of the fluid exposed to the nucleating surface when heated by the heating element.

12. The system of claim 11, further comprising an optical signal interrogator, communicatively coupled with the optical fiber sensor array, to monitor output of the sensing cable and determine the at least one property based at least in part on the output of the sensing cable.

13. The system of claim 12, wherein the optical signal interrogator is adapted to measure temperature and wherein the output of the sensing cable corresponds to a temperature measurement.

14. The system of claim 12, further comprising a control unit, coupled to the optical signal interrogator, to classify the output of the sensing cable as one of a predetermined set of classifications including at least a stable condition classification and an unstable condition classification, determined based at least in part upon the output of the sensing cable.

15. The system of claim 14, wherein the fluid is located in a tray of a distillation column.

16. The system of claim 15, wherein the optical fiber sensor array further includes a plurality of sensor locations aligned orthogonally to a bottom surface of the tray, and wherein the control unit is further configured to determine the at least one property of the fluid exposed to the sensing cable by identifying at least one interface between one or more of (a) two phases of matter present within the fluid, (b) two species present within the fluid, and (c) the fluid and a surrounding atmosphere.

17. The system of claim 16, wherein the control unit is further configured to identify the at least one interface by determining a difference in the output of the sensing cable corresponding to adjacent sensor locations of the plurality of sensor locations.

18. The system of claim 11, further comprising an excitation source, communicatively coupled with the optical signal interrogator, to control the heating element with a heat signal.

19. The system of claim 18, wherein the heat signal is chosen based at least in part on a measurement made by a secondary sensor communicatively coupled with the excitation source.

20. A system for determining at least one property of a fluid on a tray of a distillation column, comprising:
a sensing cable including an optical fiber sensor array located within the sensing cable;
a heating element aligned with the optical fiber sensor array;
a nucleating surface, at least partly surrounding the sensing cable, to induce boiling of the fluid exposed to the nucleating surface when heated by the heating element;
an optical signal interrogator, communicatively coupled with the optical fiber sensor array, to monitor output of the sensing cable and determine the at least one property based at least in part on the output of the sensing cable, wherein the optical signal interrogator is adapted to measure temperature and wherein the output of the sensing cable corresponds to a temperature measurement;
a control unit, coupled to the optical signal interrogator, to classify the output of the sensing cable as one of a predetermined set of classifications including at least a stable condition classification and an unstable condition classification, determined based at least in part upon the output of the sensing cable,
wherein the optical fiber sensor array further includes a plurality of sensor locations aligned orthogonally to a bottom surface of the tray, and wherein the control unit is further configured to determine the at least one property of the fluid exposed to the sensing cable by identifying at least one interface between one or more of (a) two phases of matter present within the fluid, (b) two species present within the fluid, and (c) the fluid and a surrounding atmosphere.
